(19) United States
(12) Patent Application Publication
(10) Pub. No.: US 2019/0166798 A9
(43) Pub. Date: Jun. 6, 2019

(54) PET TOY MADE OF MULTIPLE MATERIALS

(71) Applicant: SABINE S. CRANE, SAN CLEMENTE, CA (US)

(72) Inventor: SABINE S. CRANE, SAN CLEMENTE, CA (US)

(21) Appl. No.: 15/693,234

(22) Filed: Aug. 31, 2017

Related U.S. Application Data
(63) Continuation-in-part of application No. 29/592,753, filed on Feb. 2, 2017, now Pat. No. D844909.
Application No. 29/592,753 is a continuation-in-part of application No. 29/592,754, filed on Feb. 2, 2017, now Pat. No. D845559.
Application No. 29/592,754 is a continuation-in-part of application No. 29/592,755, filed on Feb. 2, 2017, now Pat. No. D845560.

(51) Int. Cl. A01K 15/02

(52) U.S. Cl. CPC A01K 15/026

(57) ABSTRACT

A pet toy made of multiple materials that is attractive, durable, and safe. The pet toy includes a plurality of raised features to enhance the dental cleaning action of the animal toy with the animal's mouth. The raised features may be made of varying shapes and designs and are made of a different material than the remainder of the toy. The pet has a hollow core which includes a squeaker device that further promotes play.

### STATEMENT REGARDING FEDERALLY SPONSORED RESEARCH AND DEVELOPMENT

Not Applicable.

### CROSS-REFERENCE TO RELATED APPLICATIONS

This application is related to and claims priority under 35 U.S.C. § 119(a) to U.S. Design patent application Ser. No. 29/592,753 filed Feb. 2, 2017, U.S. Design patent application Ser. No. 29/592,754 filed Feb. 2, 2017 and U.S. Design patent application Ser. No. 29/592,755 filed Feb. 2, 2017, which are each incorporated herein in their entirety by reference.

### FIELD OF THE INVENTION

This disclosure relates to pet toys made of multiple materials and processes for manufacturing pet toys.

### DISCUSSION OF RELATED ART

There is a constant need in the art to develop attractive, durable, and safe toys to entertain pets. Furthermore, there is a continued need for durable pet toys that contain squeakers. More specifically, a problem exists with some pets which attempt to “kill” the toy by gaining access to the squeaker, which can result in the undesirable choking or aspiration of the squeaker. Therefore, there is a need for a pet toy such that the squeaker is securely mounted within the pet toy and is difficult to access by the pet. The subject matter of the present disclosure is directed to meeting those needs, and others.

### SUMMARY OF THE INVENTION

Aspects of the invention provide a pet toy made of multiple materials that provides enhanced interest to pets as well as increased durability. Aspects of the invention also provide processes for making pet toys. The pet toy may include a variety of different toy shapes made of multiple materials. The inner core is made of a soft yet durable material that protrudes through a plurality of openings in the more durable outer shell. The plurality of protrusion encourages chewing and aid in dental cleaning. The inner core also includes a squeaker activated when the pet compresses the toy.

Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a cross-sectional view of the present invention;

FIG. 2 is a cross-sectional view of a squeaker of the present invention;

FIG. 3 is a perspective view of the present invention;

FIG. 4 is a plan view of the present invention;

FIG. 5 is a cross-sectional view of the inner core of the present invention;

FIG. 6 is a cross-sectional view of the outer shell of the present invention.

### DETAILED DESCRIPTION OF THE PREFERRED EMBODIMENT

Illustrative embodiments of the invention are described below. The following explanation provides specific details for a thorough understanding of and enabling description for these embodiments. One skilled in the art will understand that the invention may be practiced without such details. In other instances, well-known structures and functions have not been shown or described in detail to avoid unnecessarily obscuring the description of the embodiments.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list. When the word “each” is used to refer to an element that was previously introduced as being at least one in number, the word “each” does not necessarily imply a plurality of the elements, but can also mean a singular element.

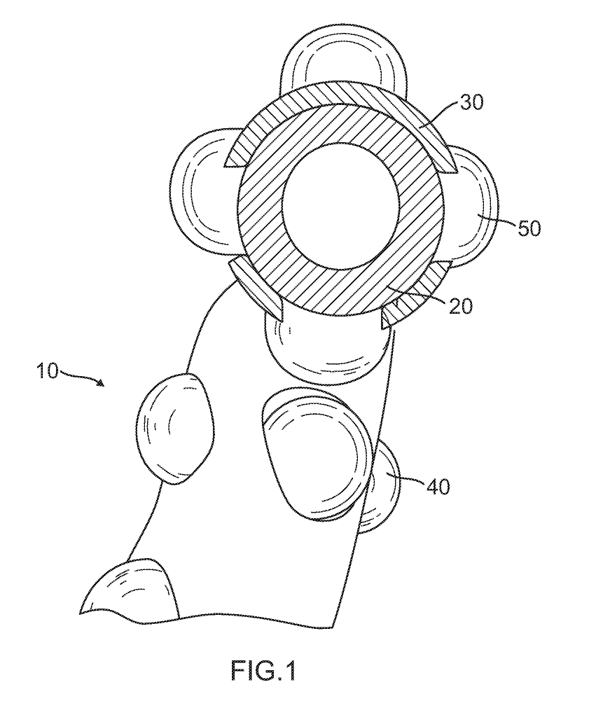

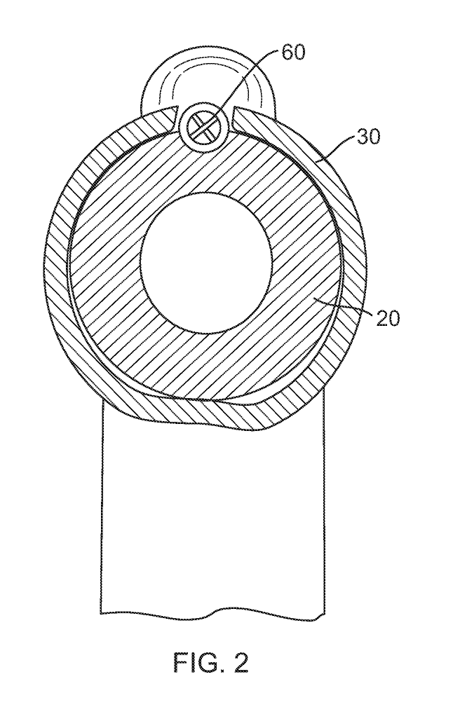

Referring to FIG. 1, a pet toy 10 is provided according to aspects of the invention and comprises a soft yet durable inner core 20 and a durable outer shell 30 meant to resemble an animal or toy. A plurality of protrusions 40 extend through a plurality of openings 50 in the outer shell 30 that encourage chewing and aid in dental cleaning. These components work in conjunction to provide a pet toy 10 that is attractive, durable, and safe. Reference numbers are provided in FIG. 1, but it will be understood that such reference numbers refer to like elements in FIGS. 2-6.

The protrusions 40 may extend linearly in groups or sets of protrusions, and the protrusions may be uniformly or randomly spaced from one another in each group or set. In each of the embodiments, the groups or sets of protrusions can extend along a desired section or portion of the pet toy, and depending upon the portion of the pet toy upon which the sets of protrusions lie, the protrusions can be either substantially equal in length as they extend along the outer surface of the pet toy, or may be dissimilar in length. Protrusions 40 have a generally rounded or bulbous shape.

In the preferred embodiment, the protrusions have a height that extends substantially perpendicular from the outer surface of the pet toy and are spaced uniformly from one another on the outer surface of the pet toy. Accordingly, the protrusions generally follow the shape or contour of the outer surface of the pet toy. The pet toy may have different shapes, for example a triangle, square or circle, or may be in the shape of an animal or other shape as desired. Depending upon the particular shape of the pet toy, there may be groups or sets of protrusions that intersect with other groups or sets of protrusions or otherwise extend away from the outer surface in a multitude of different angles. At the points of intersection, the protrusions may overlap, thereby providing additional structural strength to the pet toy in general, as well as to further stabilize a connection between the protrusions and the outer surface of the pet toy. These points of intersection also provide further enhanced dental cleaning since the overlapping configuration of the protrusions are provided in a manner to contact the animal's teeth and gums at different angles.

Primary dental cleaning occurs when the teeth and gums of the animal contact the protrusions, and the protrusions are bent or deflected as they contact the animal's teeth and gums. The protrusions can be made more or less rigid, thus resulting in the desired degree of deflection as the animal's mouth comes into contact with the protrusions. The thickness and degree of resiliency of the materials used to make the pet toy can be varied to achieve the desired dental cleaning effect and toy durability.

In an alternative embodiment, an open area or gap may be formed on the pet toy wherein the outer surface of the pet toy is exposed, and no protrusions are found in that open area. This open area may facilitate placement of a trademark or other product identifying information. In a further alternative embodiment, a plurality of raised features are formed on the outer surface of the toy. The raised features in the preferred embodiment are protrusions that extend around substantially the entire outer surface of the pet toy. The protrusions are spaced from one another along the outer surface of the pet toy

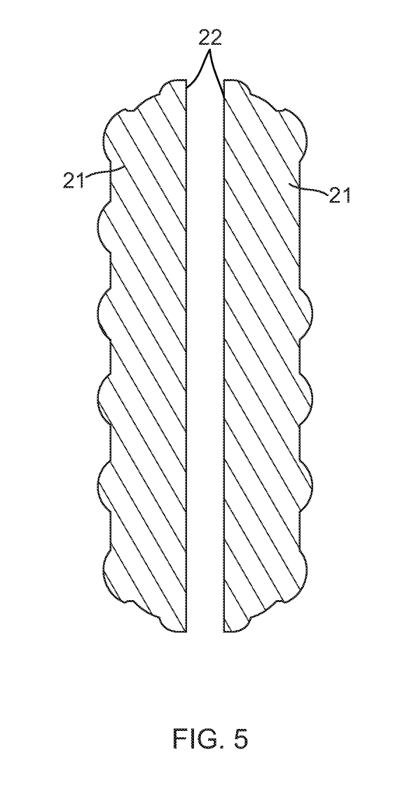

The inner elastomeric body or core 20 is made of Thermoplastic Elastomer (TPE) or other material that is soft yet durable. In the preferred embodiment inner core 20 is formed by heat sealing two halves of the inner core 21 along seam 22 to form one piece (see FIG. 5). In the preferred embodiment, the inner core 20 further comprises a squeaker 60 (see FIG. 2) that is activated when the pet compresses the toy. More specifically, the inner core 20 preferably is hollow such that, when pet toy 10 is compressed, air is forced through squeaker 60 to produce a sound.

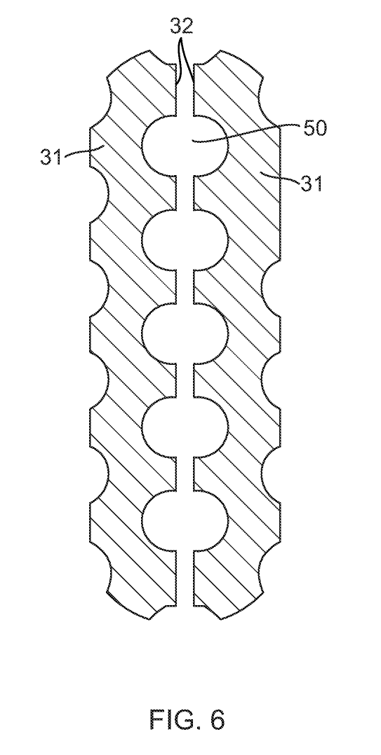

The outer elastomeric body or core 30 is preferably made of a material such as Thermoplastic Rubber (TPR) that is more durable than TPE adapted to withstand repeated pulling, biting, and similar treatment while protecting squeaker 60. Referring to FIG. 6, in the preferred embodiment the outer core is formed from two halves of the outer core 31, with the halves being glued together along seam 32. Pressure is applied when gluing out core 31. The pressure ensures that a sufficient bond is formed along seam 32. The pressure also deforms the inner core such that protrusion form in openings 50.

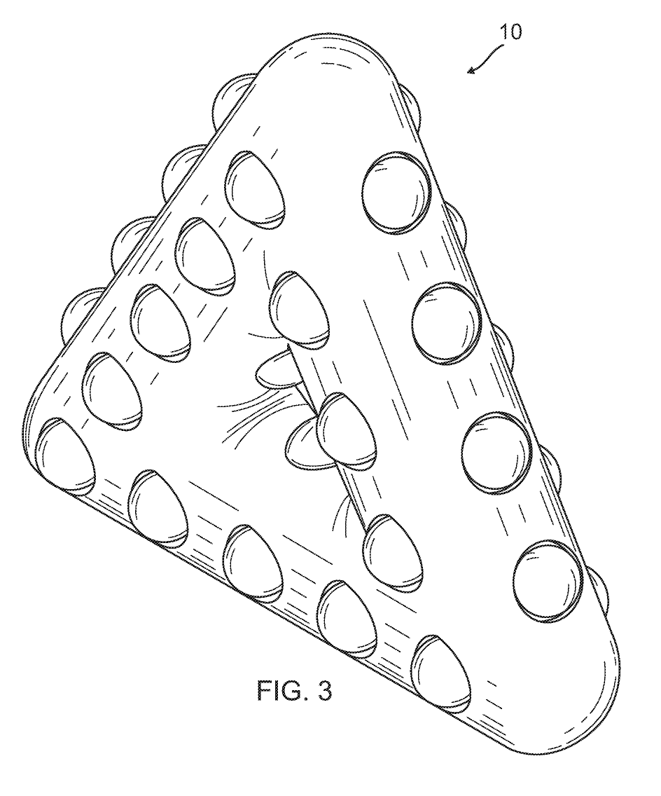

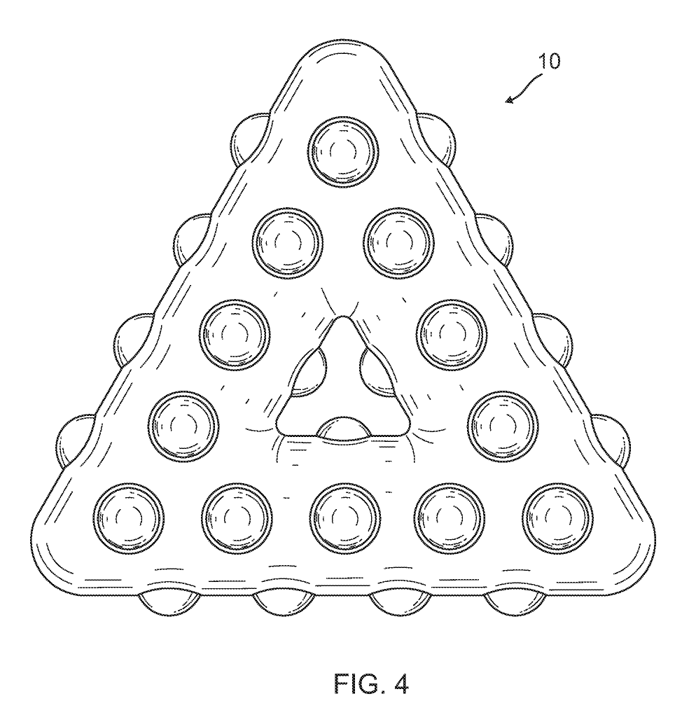

Referring to FIGS. 3 and 4, two views of a triangular embodiment of the pet toy are shown.

While a particular form of the invention has been illustrated and described, it will be apparent that various modifications can be made without departing from the spirit and scope of the invention such as making the pet toy in other geometrical and nongeometrical shapes. Accordingly, it is not intended that the invention be limited, except as by the appended claims. The actual scope of the invention encompasses not only the disclosed embodiments, but also all equivalent ways of practicing or implementing the invention.

What is claimed is:

1. A pet toy, comprising:
an inner elastomeric body member having an outer surface, and an inner surface defining a substantially hollow core;
an outer elastomeric body having an outer surface, and an inner surface defining a substantially hollow core;
a plurality of openings formed integrally with said outer surface and being exposed around the outer surface of the outer elastomeric body;
a plurality of protrusions formed by the inner elastomeric body through said openings around the outer surface of the outer elastomeric body; and
wherein said protrusions extend outwardly from the substantially hollow core of the inner elastomeric body.

2. The pet toy of claim 1, wherein said an inner elastomeric body member and said outer elastomeric body are made of different materials.

3. The pet toy of claim 2, wherein said inner elastomeric body further comprises a squeaker mechanism fixedly attached, wherein compressing said inner elastomeric body creates an audible squeak.

4. The pet toy of claim 3, wherein said inner elastomeric body comprises a plurality of sections.

5. The pet toy of claim 4, wherein said inner elastomeric body comprises thermoplastic elastomer.

6. The pet toy of claim 3, wherein said outer elastomeric body comprises a plurality of sections.

7. The pet toy of claim 6, wherein said outer elastomeric body comprises thermoplastic rubber.

8. A method of making a pet toy, comprising:
forming an inner elastomeric body member having an outer surface, and an inner surface defining a substantially hollow core;
forming an outer elastomeric body having an outer surface, and an inner surface defining a substantially hollow core;
forming a plurality of openings formed integrally with said outer surface and being exposed around the outer surface of the outer elastomeric body;
a forming a plurality of protrusions formed by the inner elastomeric body through said openings around the outer surface of the outer elastomeric body; and
wherein said protrusions extend outwardly from the substantially hollow core of the inner elastomeric body.

9. The method of making a pet toy of claim 8, wherein said an inner elastomeric body member and said outer elastomeric body are made of different materials.

10. The method of making a pet toy of claim 9, wherein said inner elastomeric body further comprises a squeaker mechanism fixedly attached, wherein compressing said inner elastomeric body creates an audible squeak.

11. The pet toy of claim 10, wherein said inner elastomeric body comprises a plurality of sections.

12. The method of making a pet toy of claim 11, wherein said inner elastomeric body comprises thermoplastic elastomer.

13. The method of making a pet toy of claim 10, wherein said outer elastomeric body comprises a plurality of sections.

14. The method of making a pet toy of claim 13, wherein said outer elastomeric body comprises thermoplastic rubber.
